(19) United States
(12) Patent Application Publication
(10) Pub. No.: US 2006/0200481 A1
(43) Pub. Date: Sep. 7, 2006

(54) Method and system for data optimization and protection in DSP firmware

(76) Inventor: Khalid Goyan, Bromma (SE)

Correspondence Address: COOPER & DUNHAM, LLP, 1185 AVENUE OF THE AMERICAS, NEW YORK, NY, 10036, US

(21) Appl. No.: 11/072,160

(22) Filed: Mar. 4, 2005

(51) Int. Cl. G06F 17/00

(52) U.S. Cl. 707/101

(57) ABSTRACT

A method and system for optimizing data includes determining whether the data is comprised of initializing zeroes, generating an empty block-when it is determined that the data is comprised of initializing zeroes, restoring the data comprised of initializing zeroes from the generated empty block, and loading the restored data comprised of initializing zeroes to memory. The method and system are used in DSP firmware.

### BACKGROUND

1. Technical Field

The present disclosure relates to DSP firmware and, more specifically, to optimizing and protecting data in DSP firmware.

2. Description of the Related Art

Digital Signal Processing (DSP) relates to the examination and manipulation of digital representations of electronic signals. Digital signals that are processed using digital signal processing are often digital representations of real-world audio and/or video.

Digital signal processing often involves examining digital signals in the time domain, spatial domain, frequency domain, autocorrelation domain, and/or wavelet domain. Converting a digital signal between domains generally involves rigorous mathematical computations. Once represented in the desired domain, additional mathematical computations may be performed on the digital signals. For example, various filters may be applied to digital signals. Digital signals may also be subjected to various compression/decompression and encryption/decryption algorithms.

Because digital signal processing often deals with digital representations audio and/or video, digital signal processing must often occur in real-time. Mathematical computations must therefore be performed on the digital signals with little or no observable delay. These mathematical computations may be performed by a general purpose computer system such as a desktop computer or workstation or by specialized digital signal processors (also abbreviated DSP). FIG. 1 is a block diagram illustrating an example of a digital signal processor.

Digital signal processors 11 are special-purpose microprocessors that have been optimized for the processing of digital signals. Digital signal processors 11 are generally designed to handle digital signals in real-time, for example, by utilizing a real-time operating system (RTOS) 12. A RTOS 12 is an operating system that may appear to handle multiple tasks simultaneously, for example, the RTOS may appear to handle tasks as the tasks are received. The RTOS 12 may prioritize tasks and allow for the interruption of low-priority tasks by high-priority tasks. The RTOS 12 generally manages memory in a way that minimizes the length of time a unit of memory is locked by one particular task while minimizing the size of the memory that is locked; allowing tasks to be performed asynchronously while minimizing the opportunity for multiple tasks to try to access the same block of memory at the same time.

Digital signal processors 11 are commonly used in embedded systems. An embedded system is a specific-purpose computer system that is integrated into a larger device. Embedded systems generally utilize a small-footprint RTOS 12 that has been customized for a particular purpose. Digital signal processing is often implemented using embedded systems comprising a digital signal processor 11 and a RTOS 12.

Digital signal processors 11 and general purpose computers may utilize direct memory access (DMA) 14 to access available memory, for example using a DMA driver. DMA 14 allows for various elements of the computer system to obtain direct access to available memory, for example, independently of the microprocessor.

Digital signal processors 11 may comprise a microprocessor along with an amount of on-chip memory (also called internal or program memory) 13. Digital signal processors 11 may also utilize external memory 15 that may be accessed by the digital signal processor 11 over an external data bus. External memory 15, for example, may be nonvolatile memory such as flash memory, EEPROM, etc. Internal memory 13 has many advantages over external memory 15, for example, internal memory 13 is generally faster and may allow for multiple simultaneous reads and/or writes. For example, internal memory 13 may be comprised of multiple internal memory banks wherein one or more of the multiple memory banks may be accessed simultaneously.

Internal memory 13 is generally volatile memory. Data stored in volatile internal memory 13 may therefore be lost when the digital signal processor 11 is powered down and/or reset. Therefore, applications and other programs that are executed on digital signal processors 11 must generally be stored in external memory 15 and downloaded into internal memory 13 during startup or at some other point prior to the execution of the application. Data so stored is often referred to as firmware.

A downloader may be used to implement the downloading of data from the external memory to the internal memory of the digital signal processor 11.

Digital signal processor 11 applications often utilize one or more data objects. Data objects may include, for example, data tables and arrays. It is common practice to initialize such data objects with zeroes where the data object has not been explicitly initialized with data. For example, the ANSI C specification requires that static data objects be initialized with zeroes by default where explicit initialization is omitted. For example, many filter algorithms and applications used by digital signal processors internally initialize variables to zero. For example, tables used by many digital signal processors algorithms may be initialized with zeroes as an efficient alternative to writing zeroes inside the tables at run-time.

Storing large data objects may reduce the efficiency of digital signal processors 11 by using up available external memory 15 and increasing the amount of data that must be read from external memory 15 at and after startup. It is therefore desirable to employ techniques that optimize data storage and retrieval by reducing the amount of storage space necessary to store large data objects.

Downloading data from the firmware to the internal memory 13 at startup also poses a security risk for digital signal processors 11. This is because data representing data, applications, and programs that are critical to the proper function of the digital signal processor 11 are generally protected as read-only data. However, the hardware and/or software that enforce the read-only status of the protected data may not be fully configured until a point after startup when one or more configuring applications may be executed. As a result, critical data, applications, and programs may be vulnerable to destruction and/or overwrite during startup. It is therefore desirable to secure the integrity of critical data, applications, and programs such that the secured data is afforded protection during startup.

### SUMMARY

A method for optimizing data includes determining whether the data is comprised of initializing zeroes, generating an empty block when it is determined that the data is comprised of initializing zeroes, restoring the data comprised of initializing zeroes from the generated empty block, and loading the restored data comprised of initializing zeroes to memory.

A system for optimizing data includes a firmware builder for determining whether the data is comprised of initializing zeroes and generating an empty block when it is determined that the data is comprised of initializing zeroes, firmware for storing the generated empty block, and a downloader for restoring the data comprised of initializing zeroes from the generated empty block stored in the firmware and loading the restored data comprised of initializing zeroes to memory.

A computer system includes a processor and a program storage device readable by the computer system, embodying a program of instructions executable by the processor to perform method steps for optimizing data. The method includes determining whether the data is comprised of initializing zeroes, generating an empty block when it is determined that the data is comprised of initializing zeroes, restoring the data comprised of initializing zeroes from the generated empty block, and loading the restored data comprised of initializing zeroes to memory.

A method for securing data includes determining whether the data is to be protected, generating a data block including the data, flagging the data block as protected when it is determined that the data is to be protected, loading the data from the data block to internal memory, and protecting the data loaded into internal memory when the data block has been flagged as protected.

A system for securing data includes a determining unit for determining whether the data is to be protected, a firmware builder for generating a data block includes the data, a flagging unit for flagging the data block as protected when it is determined that the data is to be protected, a downloader for loading the data from the data block to internal memory, and a protecting unit for protecting the data loaded into internal memory when the data block has been flagged as protected.

A computer system includes a processor and a program storage device readable by the computer system, embodying a program of instructions executable by the processor to perform method steps for securing data. The method includes determining whether the data is to be protected, generating a data block includes the data, flagging the data block as protected when it is determined that the data is to be protected, loading the data from the data block to internal memory, and protecting the data loaded into internal memory when the data block has been flagged as protected.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating an example of a digital signal processor;

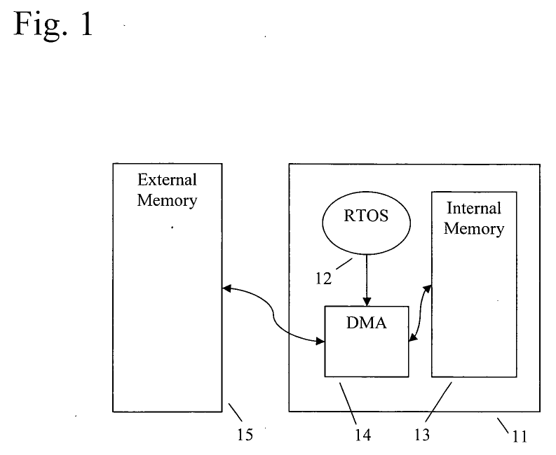

FIG. 2 is a block diagram illustrating a structure of a data block;

FIG. 3 is a block diagram illustrating a structure of a data block according to an embodiment of the present invention;

FIG. 4 is a flow chart illustrating a method for optimizing data using empty blocks according to an embodiment of the present invention;

FIG. 5 is a block diagram showing a protected data block according to an embodiment of the present invention;

FIG. 6 is a flow chart illustrating a method for protecting data according to an embodiment of the present invention; and

FIG. 7 is a diagram of an exemplary computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Firmware Data Optimization

Applications that may be executed on digital signal processors may first be compiled. During compilation, a compiler may be used to convert the application source code into binary machine code that may be interpreted by the digital signal processor. After the applications are compiled a linker may be used to link the executable objects. Linking executable objects generally involves combining one or more compiled executable objects and/or library functions into a single executable object in satisfaction of one or more dependencies. After an executable object has been linked, a firmware builder may be used to convert the linked executable objects into a format that is suitable for incorporation into a programmable device such as firmware.

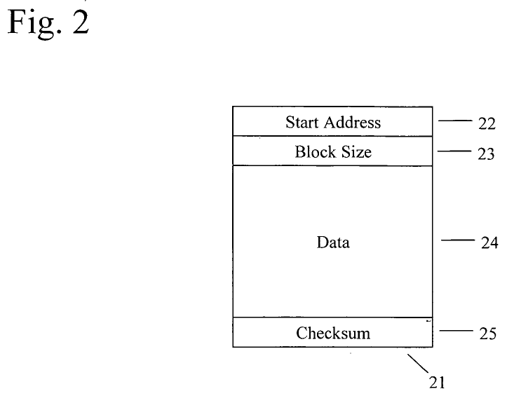

Data stored in firmware may be comprised of one or more discrete data blocks. FIG. 2 is a block diagram illustrating a structure of a data block. A data block 21 may comprise a start address 22. The start address 22 may indicate the first location in memory that the data block 21 occupies. The data block 21 may additionally comprise a block size 23. The block size indicates how much memory the data block 21 utilizes. When taken together, the start address 22 and the block size 23 describe what area of the memory is devoted to the particular data block 21. This information may be used to allow the data block 21 to be effectively downloaded to internal memory of a digital signal processor. The data block 21 may also comprise a data section 24. The data section 24 may be used to store the substance of the data block. For example, application code and/or data objects may be stored in the data section 24 of a data block. The data block 21 may additionally comprise a checksum section 25. The checksum section may store a checksum that has been calculated based on the data stored in the data section 24 and/or the data block 21. The checksum may be used to verify the accuracy of the data after it has been copied to the internal memory, for example, at startup.

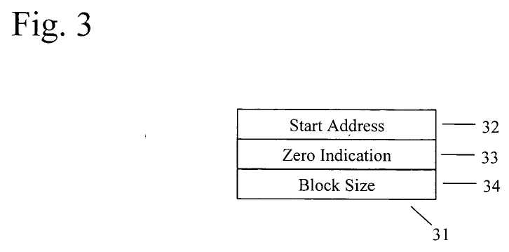

Embodiments of the present invention seek to increase speed and economy of memory for digital signal processors by excluding initializing zeroes from data objects such as, for example, data tables and arrays. According to an embodiment of the present invention, data blocks may be capable of representing initializing zeroes to be used in data objects such as data tables and arrays without needing to include all of the initializing zeroes. FIG. 3 is a block diagram illustrating a structure of a data block according to an embodiment of the present invention. This data block 31 may be used in place of data blocks that contain initializing zeroes. The data block 31 may have a start address 32 and a block size 34. The data block 31 may also have a zero indication section 33 that may be used to indicate that the data block 31 represents a data block of initializing zeroes. The data block 31 need not have a data section and may therefore be referred to as an empty block. The zero indication section 33 may be a single bit capable of receiving a value of one or zero. For example, the zero indication bit 33 may be set to zero when the block 31 is not an empty block and the zero indication bit 33 may be set to one when the block 31 is an empty block. Alternatively, a value of zero may be used to indicate an empty block.

According to another embodiment of the present invention, the zero indication section 33 may be part of the block size section 34. For example, a block size of zero or a negative block size may indicate that the block is an empty block while a positive and non-zero block size may indicate that the block is not an empty block.

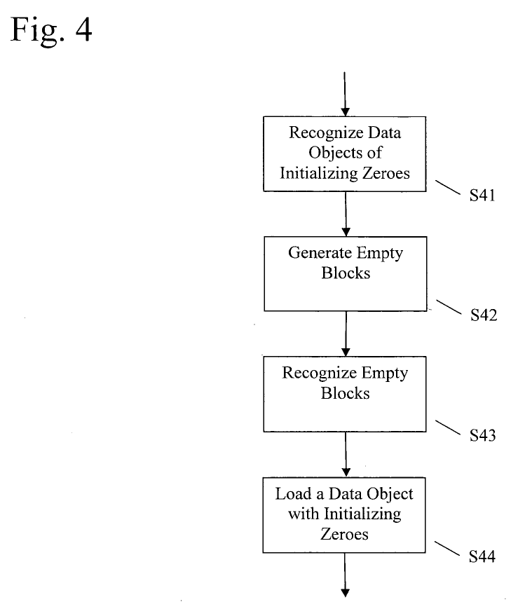

The empty blocks described above may be used to conserve memory resources used for storing firmware on digital signal processors by optimizing the way data is stored. FIG. 4 is a flow chart illustrating a method for optimizing data using empty blocks according to an embodiment of the present invention. When engaged in the process of firmware generation, the firmware builder, for example, may recognize data objects of initializing zeroes from the compiled and/or linked code being used to generate firmware (Step S41). The firmware builder may then generate empty blocks for the data objects of initializing zeroes (Step S42). The empty blocks may therefore be incorporated into the firmware in place of blocks of initializing zeroes. When the firmware is downloaded into the internal memory of the digital signal processor, for example by a downloader, the empty blocks may be recognized (Step S43), for example by examining a zero indication section of the block. The downloader may then load a data object with initializing zeroes to the internal memory of the digital signal processor (Step S44) in place of the recognized empty block.

Application Data Protection

Embodiments of the present invention seek to preserve the integrity of digital signal processor applications and/or programs that may be downloaded from external memory to internal memory of a digital signal processor. The integrity of digital signal processor applications and/or programs may be preserved by designating data representing data, applications, and programs that are critical to the proper function of the digital signal processor as read-only. Read-only status may then be effectuated by the use of hardware and/or software protections, for example a hardware protection device.

According to an embodiment of the present invention, protection of the critical data, for example, critical applications, may be implemented as the data is downloaded from external memory to the internal memory of the digital signal processor. By protecting the critical data as this early stage, the chances for overwriting critical data during startup may be reduced when compared to other methods for protecting data known in the art.

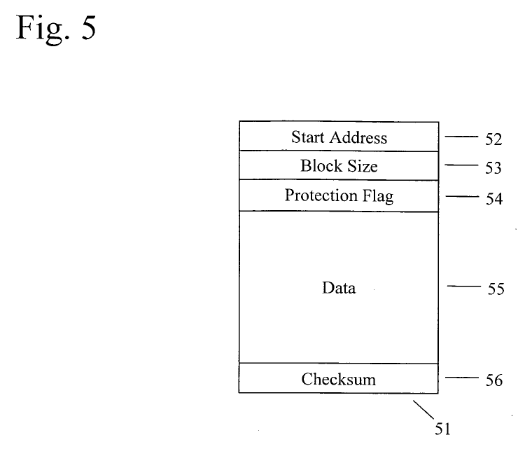

FIG. 5 is a block diagram showing a protected data block according to an embodiment of the present invention. The data block 51 may comprise a start address section 52 for storing a start address, a block size section 53 for storing a block size, a data section 55 for storing data, and a checksum section 56 for storing a checksum. The data block 51 may additionally comprise a protection flag section 54 for storing a protection flag. The protection flag may indicate whether the data block 51 represents a critical data block to be protected. The protection flag may be generated, for example, by the linker during linking. Alternatively, the protection flag may be generated, for example, by the firmware builder during firmware generation. The protection flag section 54 may be generated by the firmware builder during firmware generation when the data block 51 is generated.

According to one embodiment of the present invention, when linking an application by using the linker, the user can tell the linker that a specific data section should be annotated, for example marked or flagged, as protected. The linker may be extended to support this scenario. The protection information may be embedded into the output format of the linker. For example, the protection information may be embedded into an object file in the ELF format. During firmware generation, the firmware builder may extract both data and protection information from the object file that has been previously generated by the linker and insert this information, for example the protection flag, into the firmware.

The protection flag may be a single bit that indicates whether the data block is to be protected. For example, a one value may indicate that the data block is to be protected while a zero value may indicate that the data block is not to be protected. Alternatively, a zero value may indicate protected status. The protection flag, for example, may be part of the block size field 53.

When a protected data block is loaded into the internal memory by the downloader, for example at startup, the data block may be examined to determine whether the data block is to be protected. When it is determined that the data block is a protected data block, the start address and the block size may be used to configure hardware and/or software protections, for example a hardware protection device. The hardware protection device may then be able to protect the corresponding data residing in internal memory, for example, from the moment the data is loaded into the internal memory thereby protecting the data, even during the remainder of startup.

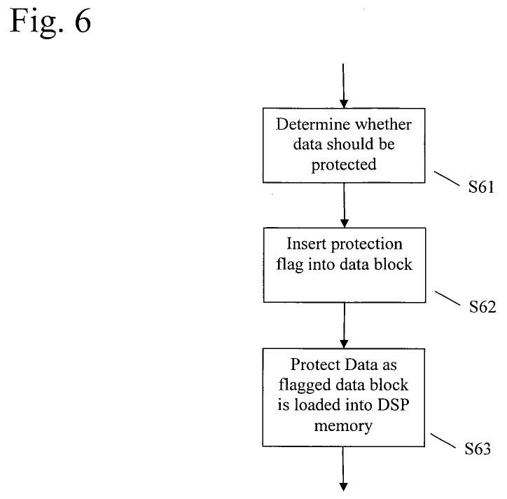

FIG. 6 is a flow chart illustrating a method for protecting data according to an embodiment of the present invention. It may first be determined whether data should be protected (Step S61). Where it is determined that the data should be protected, a protection flag may be inserted into a data block that has been generated to store the data (Step S62). As data is downloaded from data blocks to internal memory of a digital signal processor, data is protected on the internal memory of the digital signal processor when the data block for storing the data contains a protection flag (Step S63).

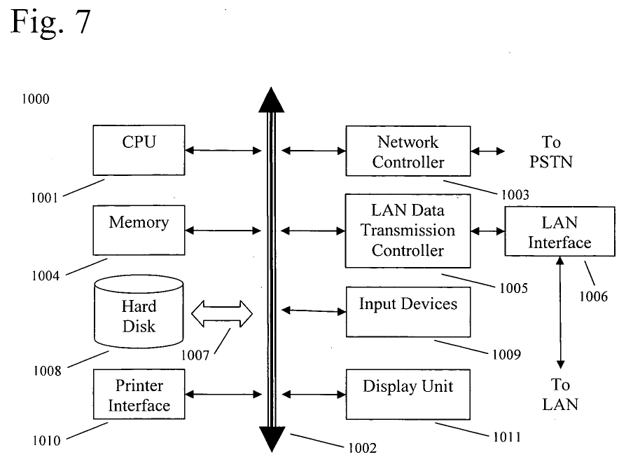

FIG. 7 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for optimizing data, comprising:
determining whether the data is comprised of initializing zeroes;
generating an empty block when it is determined that the data is comprised of initializing zeroes;
restoring the data comprised of initializing zeroes from the generated empty block; and
loading the restored data comprised of initializing zeroes to memory.

2. The method of claim 1, wherein the data is data used to generate firmware.

3. The method of claim 1, wherein the step of determining whether data is comprised of initializing zeroes is performed by a firmware builder during generation of firmware.

4. The method of claim 1, wherein the empty block is a data block with a zero indication indicating that the data block is an empty block.

5. The method of claim 1, wherein the step of restoring the data comprised of initializing zeroes from the generated empty block comprises:
reading the empty block from the firmware of a digital signal processor; and
interpreting the empty block as data comprised of initializing zeroes.

6. The method of claim 1, wherein the memory is memory internal to a digital signal processor.

7. The method of claim 1, wherein the data is a data object.

8. The method of claim 7, wherein the data object is a table.

9. The method of claim 7, wherein the data object is an array.

10. The method of claim 1, wherein the step of restoring of the data comprised of initializing zeroes from the generated empty block and the loading of the restored data comprised of initializing zeroes to memory are performed by a downloader while downloading digital signal processor firmware to memory internal to a digital signal processor.

11. A system for optimizing data, comprising:
a firmware builder for determining whether the data is comprised of initializing zeroes and generating an empty block when it is determined that the data is comprised of initializing zeroes;
firmware for storing the generated empty block; and
a downloader for restoring the data comprised of initializing zeroes from the generated empty block stored in the firmware and loading the restored data comprised of initializing zeroes to memory.

12. The system of claim 11, wherein the data is a data object.

13. The system of claim 12, wherein the data object is a table.

14. The system of claim 12, wherein the data object is an array.

15. The system of claim 11, wherein the empty block is a data block comprising:
a start address section;
a zero indication section; and
a block size section.

16. The system of claim 15, wherein:
the start address section stores an address of the start of the empty block in the firmware;
the zero indication section stores a zero indicator indicating that the empty block is an empty block; and
the block size section stores the size of the empty block in the firmware.

17. The system of claim 16, wherein the zero indicator is a single bit.

18. The system of claim 11, wherein the empty block is a data block comprising:
a start address section; and
a block size section.

19. The system of claim 18, wherein the start address section stores an address of the start of the empty block in the firmware; and
the block size section stores the size of the empty block in the firmware, wherein a stored block size less than or equal to zero indicates that the empty block is an empty block.

20. A computer system comprising:
a processor; and
a program storage device readable by the computer system, embodying a program of instructions executable by the processor to perform steps for optimizing data, the steps comprising:
determining whether the data is comprised of initializing zeroes;
generating an empty block when it is determined that the data is comprised of initializing zeroes;
restoring the data comprised of initializing zeroes from the generated empty block; and
loading the restored data comprised of initializing zeroes to memory.

21. A method for securing data, comprising:
determining whether the data is to be protected;
generating a data block comprising the data;
flagging the data block as protected when it is determined that the data is to be protected;
loading the data from the data block to internal memory; and
protecting the data loaded into internal memory when the data block has been flagged as protected.

22. The method of claim 21, wherein the data is to be protected when the data is critical data.

23. The method of claim 21, wherein the steps of generating a data block comprising the data comprises:
creating a data block;
adding a start address to the data block;
adding a block size to the data block;
adding the data to the data block; and
adding a checksum to the data block, and
the step of flagging the data block as protected when it is determined that the data is to be protected comprises:
adding a protection flag to the data block when it is determined that the data is to be protected.

24. The method of claim 23, wherein the protection flag is a single bit.

25. The method of claim 23, wherein the protection flag is part of the block size.

26. The method of claim 23, wherein generating a data block additionally comprises saving the data block to memory external to a digital signal processor.

27. The method of claim 26, wherein the memory external to a digital signal processor is firmware.

28. The method of claim 27, wherein the generating a data block comprising the data is performed by a firmware builder.

29. The method of claim 21, wherein the data is an application for a digital signal processor.

30. The method of claim 21, wherein the internal memory is memory internal to a digital signal processor.

31. The method of claim 21, wherein the steps of loading the data from the data block to internal memory and protecting the data loaded into internal memory when the data block has been flagged as protected are preformed during startup of a digital signal processor.

32. The method of claim 21, wherein the steps of loading the data from the data block to internal memory and protecting the data loaded into internal memory when the data block has been flagged as protected are preformed by a downloader.

33. The method of claim 21, wherein data to be protected is read-only data.

34. The method of claim 21, wherein the steps of protecting the data loaded into internal memory when the data block has been flagged as protected comprises configuring a hardware protection device to protect the memory in internal memory.

35. A system for securing data, comprising:
a determining unit for determining whether the data is to be protected;
a firmware builder for generating a data block comprising the data;
a flagging unit for flagging the data block as protected when it is determined that the data is to be protected;
a downloader for loading the data from the data block to internal memory; and
a protecting unit for protecting the data loaded into internal memory when the data block has been flagged as protected.

36. The system of claim 35, wherein the data is to be protected when the data is critical data.

37. The system of claim 35, wherein generating a data block comprising the data comprises:
creating a data block;
adding a start address to the data block;
adding a block size to the data block;
adding the data to the data block; and
adding a checksum to the data block, and
flagging the data block as protected when it is determined that the data is to be protected comprises:
adding a protection flag to the data block when it is determined that the data is to be protected.

38. The system of claim 37, wherein the protection flag is a single bit.

39. The system of claim 37, wherein the protection flag is part of the block size.

40. The system of claim 37, wherein generating a data block additionally comprises saving the data block to memory external to a digital signal processor.

41. The system of claim 35, wherein the data is an application for a digital signal processor.

42. The system of claim 35, wherein the internal memory is memory internal to a digital signal processor.

43. The system of claim 35, wherein loading the data from the data block to internal memory and protecting the data loaded into internal memory when the data block has been flagged as protected are preformed during startup of a digital signal processor.

44. The system of claim 35, wherein data to be protected is read-only data.

45. The system of claim 35, wherein protecting the data loaded into internal memory when the data block has been flagged as protected comprises configuring the protecting unit to protect the memory in internal memory.

46. The system of claim 35, wherein the protecting unit is a hardware protection device.

47. A computer system comprising:
a processor; and
a program storage device readable by the computer system, embodying a program of instructions executable by the processor to perform a method for securing data, the method comprising:
determining whether the data is to be protected;
generating a data block comprising the data;
flagging the data block as protected when it is determined that the data is to be protected;
loading the data from the data block to internal memory; and
protecting the data loaded into internal memory when the data block has been flagged as protected.
